(19) United States
(12) Patent Application Publication
(10) Pub. No.: US 2021/0012232 A1
(43) Pub. Date: Jan. 14, 2021

(54) FAULT TRANSFER DIAGNOSIS METHOD FOR ROLLING ELEMENT BEARINGS BASED ON POLYNOMIAL KERNEL INDUCED FEATURE DISTRIBUTION ADAPTATION

(71) Applicant: Xi'an Jiaotong University, Xi'an (CN)

(72) Inventors: Yaguo LEI, Xi'an (CN); Yuan WANG, Xi'an (CN); Bin YANG, Xi'an (CN); Naipeng LI, Xi'an (CN)

(73) Assignee: Xi'an Jiaotong University, Xi'an (CN)

(21) Appl. No.: 16/861,226

(22) Filed: Apr. 29, 2020

(30) Foreign Application Priority Data
Jul. 10, 2019 (CN) 201910619506.3

(51) Int. Cl. G06N 7/00; G01M 13/045; G06N 3/08

(52) U.S. Cl. CPC G06N 7/005; G06N 3/08; G01M 13/045

(57) ABSTRACT

A fault transfer diagnosis method for rolling element bearings based on polynomial kernel induced feature distribution adaptation includes: inputting the data set of the source rolling element bearings and the monitoring data set from the target rolling element bearings into the deep residual network; extracting the transferrable fault features of the source and the transferrable fault features of the target layer by layer; minimizing the distribution discrepancy by the polynomial kernel induced feature adaptation; inputting the transferrable fault features of the target into the Softmax classifier to obtain the probability distribution of the specific state of the target samples; converting the probability distribution into the pseudo labels of the target samples; training the transfer diagnosis model; inputting the monitoring data of the target bearings into the trained diagnostic model, and outputting the label probability distribution corresponding to the data samples.

### CROSS REFERENCE TO THE RELATED APPLICATIONS

This application is based upon and claims priority to Chinese Patent Application No. 201910619506.3, filed on Jul. 10, 2019, the entire contents of which are incorporated herein by reference.

### TECHNICAL FIELD

The present invention belongs to the technical field of rolling element bearing fault diagnosis, and particularly to a fault transfer diagnosis method for a rolling element bearing based on polynomial kernel induced feature distribution adaptation.

### BACKGROUND

Rolling element bearings play an important part in rotating machinery, and generally directly affect the overall performance of mechanical equipment in use. Therefore, it is significant to perform fault diagnosis for rolling element bearings in the practical engineering applications. Intelligent fault diagnosis has become an active research area in fault diagnosis technology because it can automatically extract fault features and detect the health states of machines by using machine learning theories . Since the deep learning theory and technology are rapidly developing and are gradually applied to the intelligent fault diagnosis of bearings, the accuracy and intelligence of fault diagnosis for bearings are remarkably improved. The performance and reliability of deep learning-based intelligent diagnosis rely on training diagnosis models with sufficient labeled monitoring data of bearings, which is usually unrealistic in the practical engineering scenarios. Transfer fault diagnosis can utilize the existing bearing fault diagnosis knowledge to solve the related yet different bearing fault diagnosis problems and overcome the issues of the massive bearing data with a small number of labeled samples.

Feature distribution adaptation is one of the most commonly used methods in transfer fault diagnosis. Feature distribution adaptation aims to construct a transfer diagnosis model, which is able to reduce the distribution discrepancy of features extracted both from the monitoring data of the source bearings the target bearings. As a result, the fault diagnosis knowledge of the source bearings can be used to identify the health state of the target bearings. Currently, the feature distribution adaptation methods generally adopt the maximum mean discrepancy to measure and further adapt the distribution discrepancy of extract features, which is commonly induced by Gaussian kernels. However, the Gaussian kernel based adaptation methods have following obvious disadvantages: (1) the feature distribution adaptation methods based on the Gaussian kernels only considers the distribution discrepancy on the first-order moment, that is, the distribution discrepancy on the mean value, but ignores the distribution discrepancy on the higher-order moments, which leads to the inaccurate measurement of the feature distribution discrepancy and the low accuracy of the transfer diagnosis of the diagnostic models; (2) the calculation of the feature distribution adaptation method based on the Gaussian kernel induced is complicated and time-consuming (the time spent on the calculation is relatively long), which causes an increasing difficulty in the training of transfer diagnosis models; (3) the feature distribution adaptation of the Gaussian kernel induced is very sensitive to the change of kernel parameters, and thus, the output change is unstable and the model parameters are difficult to be adjusted.

### SUMMARY

In order to overcome the shortcomings of the prior art, an object of the present invention is to provide a fault transfer diagnosis method for rolling element bearings based on polynomial kernel induced feature distribution adaptation, which can detect the health state showing whether the rolling element bearings are faulty or not, improve the performance and the training efficiency of the transfer diagnosis model, and reduce the difficulty of parameter adjustment.

In order to achieve the above purposes, the technical solution adopted by the present invention is as follows.

A fault transfer diagnosis method for rolling element bearings based on polynomial kernel induced feature distribution adaptation, including the following steps:

step 1: obtaining R kinds of sample data set {(xᵢ^{s},yᵢ^{s})}ᵢ₌₁ⁿ^{ₛ} with health state labels from source rolling element bearings, wherein, xᵢ^{s}∈R^{N×1} is an i^{th} source sample and is composed of N vibration signal data points, corresponding health state labels of the bearings are yᵢ∈{1, 2, 3, . . . , R}, and nₛ is a number of labeled samples; and obtaining monitoring data set {xᵢ^{t}}ᵢ₌₁ⁿ^{ₜ} from target rolling element bearings, wherein nₜ is a number of unlabeled samples;

step 2: inputting the data of the source bearings and the data of the target bearings into a domain-sharing deep residual network; extracting transferrable fault features in both the data of the source domain bearings and the data of the target domain bearings layer by layer to obtain the transferrable fault features x^{s,F}^{₂}=ƒ_{θ}(xᵢ^{s}) of the source bearings and the transferrable fault features x^{t,F}^{₂}=ƒ_{θ}(xᵢ^{t}) of the target bearings;

step 3: adopting a maximum mean discrepancy measurement method with polynomial kernel induced to measure the distribution discrepancy of the transferrable fault features in the data of the source bearings and the data of the target bearings as follows:

$${D}_{ℋ}^{2} ( {x}_{i}^{s , {F}_{2}} , {x}_{i}^{t , {F}_{2}} ) = {\sum }_{j = 1}^{c} ( \begin{matrix}c \\ j\end{matrix} ) {a}^{j} {b}^{c - j} {‖ {E ( {x}_{i}^{s , {F}_{2}} )}_{j} - {E ( {x}_{i}^{t , {F}_{2}} )}_{j} ‖}_{ℋ}^{2} , \\ wherein , \\ \{ \begin{matrix}{‖ {E ( {x}_{i}^{s , {F}_{2}} )}_{j} - {E ( {x}_{i}^{t , {F}_{2}} )}_{j} ‖}_{ℋ}^{2} = {\sum }_{q = 0}^{j} ( \begin{matrix}j \\ q\end{matrix} ) ( {v}_{q}^{T} \cdot {μ}_{j - q} ) \\ {v}_{q}^{T} = [ {E [ {Λ}_{xx} - E ( {Λ}_{xx} ) ]}^{q} , {E [ {Λ}_{yy} - E ( {Λ}_{yy} ) ]}^{q} , {E [ {Λ}_{xy} - E ( {Λ}_{xy} ) ]}^{q} ] \\ {μ}_{j - q} = {[ {E ( {Λ}_{xx} )}^{j - q} , {E ( {Λ}_{yy} )}^{j - q} , - 2 {E ( {Λ}_{xx} )}^{j - q} ]}^{T} \\ \begin{matrix}{Λ}_{xx} = [ 〈 {x}_{1}^{s , {F}_{2}} , {x}_{1}^{s , {F}_{2}} 〉 , … , 〈 {x}_{1}^{s , {F}_{2}} , {x}_{n}^{s , {F}_{2}} 〉 , … , \\ {〈 {x}_{n}^{s , {F}_{2}} , {x}_{1}^{s , {F}_{2}} 〉 , … , 〈 {x}_{n}^{s , {F}_{2}} , {x}_{n}^{s , {F}_{2}} 〉 ]}^{T}\end{matrix} \\ \begin{matrix}{Λ}_{yy} = [ 〈 {x}_{1}^{t , {F}_{2}} , {x}_{1}^{t , {F}_{2}} 〉 , … , 〈 {x}_{1}^{t , {F}_{2}} , {x}_{n}^{t , {F}_{2}} 〉 , … , \\ {〈 {x}_{n}^{t , {F}_{2}} , {x}_{1}^{t , {F}_{2}} 〉 , … , 〈 {x}_{n}^{t , {F}_{2}} , {x}_{n}^{t , {F}_{2}} 〉 ]}^{T}\end{matrix} \\ \begin{matrix}{Λ}_{xy} = [ 〈 {x}_{1}^{s , {F}_{2}} , {x}_{1}^{t , {F}_{2}} 〉 , … , 〈 {x}_{1}^{s , {F}_{2}} , {x}_{n}^{t , {F}_{2}} 〉 , … , \\ {〈 {x}_{n}^{s , {F}_{2}} , {x}_{1}^{t , {F}_{2}} 〉 , … , 〈 {x}_{n}^{s , {F}_{2}} , {x}_{n}^{t , {F}_{2}} 〉 ]}^{T}\end{matrix}\end{matrix} ,$$

[symbol] represents a reproducing kernel Hilbert space, and a, b, c represent a slope, an intercept and an order of the polynomial kernel function, respectively;

step 4: inputting the transferrable fault features obtained in step 2 into an output layer F₃ of the deep residual network, and adopting an activation function Softmax to generate a probability distribution [symbol] of a health state of input samples as follows:

[symbol]

=[P( [symbol] =q| [symbol] ;θ^{F}^{₃})]_{q=1}^{k},

wherein, a probability calculation formula of a q^{th} sample is as follows:

$$P ( {y}_{i}^{𝒟} = q \vert {x}_{i}^{𝒟 , {F}_{2}} ; {θ}^{{F}_{3}} ) = \frac{exp ( {w}_{q}^{{F}_{3}} \cdot {x}_{i}^{𝒟 , {F}_{2}} + {b}_{q}^{{F}_{3}} )}{{\sum }_{q = 1}^{ϕ} exp ( {w}_{q}^{{F}_{3}} \cdot {x}_{i}^{𝒟 , {F}_{2}} + {b}_{q}^{{F}_{3}} )} ,$$

wherein, θ^{F}^{₃}={w^{F}^{₃},b^{F}^{₃}} is a parameter to be trained of the output layer F₃ and [symbol] is a bearing data identifier;

then, converting the probability distribution into pseudo labels of the target samples:

ŷᵢ^{t}=[ŷ₁^{t} ŷ₂^{t} . . . ŷ_{q}^{t} . . . ŷₖ^{t}],

wherein,

$${\hat{y}}_{q}^{t} = \{ \begin{matrix}1 & q = {arg max}_{q} {Γ}_{i}^{t} \\ 0 & others\end{matrix} ;$$

step 5: combining the distribution discrepancy [symbol] (xᵢ^{s,F}^{₂},xᵢ^{t,F}^{₂}) of the transferrable fault features obtained in step 3 with the pseudo label ŷᵢ^{t} of the target bearing samples obtained in step 4 to train the transfer diagnosis model, that is, minimize an objective function:

$$J ( θ ) = - \frac{1}{{n}_{s}} {\sum }_{i = 1}^{{n}_{s}} {( {y}_{i}^{s} )}^{T} \cdot ln ( {Γ}_{i}^{s} ) + β \cdot {D}_{ℋ}^{2} ( {x}_{i}^{s , {F}_{2}} , {x}_{i}^{t , {F}_{2}} ) - α \cdot \frac{1}{{n}_{t}} {\sum }_{j = 1}^{{n}_{t}} {( {\hat{y}}_{j}^{t} )}^{T} \cdot ln ( {Γ}_{j}^{t} ) ,$$

wherein, α is a tradeoff parameter of a transferrable fault feature distribution adaptation item, β is a tradeoff parameter of a pseudo label training item, and θ is a parameter to be trained.

step 6: inputting the monitoring data of the target bearings into a trained transfer diagnosis model, outputting a label probability distribution corresponding to the features of the data samples, and taking sample labels corresponding to a maximum probability as the health states {yᵢ^{t}}ᵢ₌₁ⁿ^{ₜ} of the bearings.

The advantages of the present invention are listed as follows. The present invention estimates the distribution discrepancy of the features by using the statistical value of the features on the multi-order moments, which improves the diagnostic performance of the transfer diagnosis model. The cyclic nesting in the process of calculating the maximum mean discrepancy of the Gaussian kernel induced is transformed into matrix operation, which greatly reduces the running time of the algorithm and lowers the difficulty of parameter adjustment. By combining the advantage of the deep residual network with the advantage of the polynomial kernel induced feature distribution adaptation, the transfer diagnosis model can directly extract features from the original vibration signal of the rolling element bearing in the laboratory and adapt the features to a specific state, and then transfers the diagnosis knowledge to the fault diagnosis of rolling element bearings in the actual engineering environment.

### BRIEF DESCRIPTION OF THE DRAWINGS

FIG. 1 is a flow chart of the present invention.

FIG. 2 shows the domain-sharing deep residual network structure.

FIG. 3 shows the training process of the deep transfer diagnosis model.

FIG. 4(a) and FIG. 4(b) show the changes of the transfer diagnosis performance of the model with the kernel parameters, wherein FIG. 4(a) is polynomial kernel induced; FIG. 4(b) is Gaussian kernel induced.

### DETAILED DESCRIPTION OF THE EMBODIMENTS

The present invention is further described in detail below in combination with the drawings and embodiments.

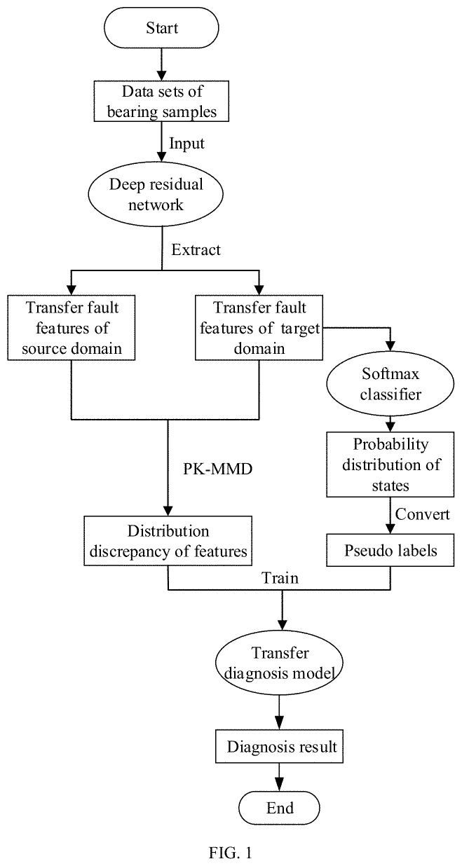

As shown in FIG. 1, a fault transfer diagnosis method for a rolling element bearing based on polynomial kernel induced feature distribution adaptation includes the following steps.

Step 1: R kinds of sample data set {(xᵢ^{s},yᵢ^{s})}ᵢ₌₁ⁿ^{ₛ} with health state labels from the source rolling element bearings are obtained, wherein, xᵢ^{s}∈R^{N×1} is an i^{th} source sample and is composed of N vibration signal data points, the corresponding health state label of the bearing is yᵢ∈{1, 2, 3, . . . , R}, and nₛ is the number of labeled samples; and the monitoring data set {xᵢ^{t}}ᵢ₌₁ⁿₜ from the target rolling element bearing are obtained, wherein nₜ is the number of unlabeled samples.

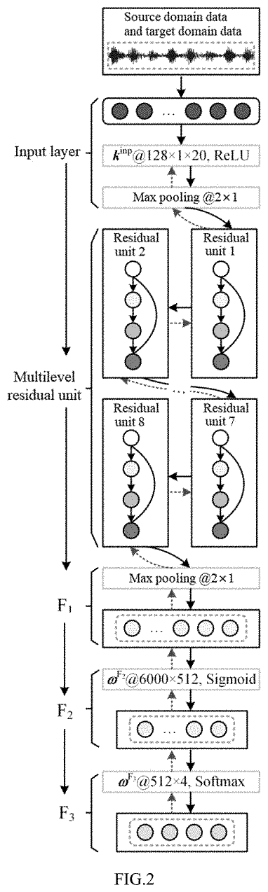

Step 2: the data of the source bearings and the data of the target bearings are inputted into the domain-sharing deep residual network; as shown in FIG. 2, the transferrable fault features in both the data of the source bearings and the data of the target bearings are extracted layer by layer to obtain the transferrable fault feature x^{s,F}^{₂} =ƒ_{θ}(xᵢ^{s}) of the source bearings and the transferrable fault feature x^{t,F}^{₂}=ƒ_{θ}(xᵢ^{t}) of the target bearings, wherein, ƒ(⋅) is the deep residual network model , θ is the parameter to be trained and F₂ represents the intermediate hidden layer of full-connected layer.

Step 3: the maximum mean discrepancy measurement method with the polynomial kernel induced is adopted to measure the distribution discrepancy of the transferrable fault features in the data of the source bearings and the data of the target bearings as follows:

$${D}_{ℋ}^{2} ( {x}_{i}^{s , {F}_{2}} , {x}_{i}^{t , {F}_{2}} ) = {\sum }_{j = 1}^{c} ( \begin{matrix}c \\ j\end{matrix} ) {a}^{j} {b}^{c - j} {‖ {E ( {x}_{i}^{s , {F}_{2}} )}_{j} - {E ( {x}_{i}^{t , {F}_{2}} )}_{j} ‖}_{ℋ}^{2} , \\ wherein$$

$$\{ \begin{matrix}{‖ {E ( {x}_{i}^{s , {F}_{2}} )}_{j} - {E ( {x}_{i}^{t , {F}_{2}} )}_{j} ‖}_{ℋ}^{2} = {\sum }_{q = 0}^{j} ( \begin{matrix}j \\ q\end{matrix} ) ( {v}_{q}^{T} \cdot {μ}_{j - q} ) \\ {v}_{q}^{T} = [ {E [ {Λ}_{xx} - E ( {Λ}_{xx} ) ]}^{q} , {E [ {Λ}_{yy} - E ( {Λ}_{yy} ) ]}^{q} , {E [ {Λ}_{xy} - E ( {Λ}_{xy} ) ]}^{q} ] \\ {μ}_{j - q} = {[ {E ( {Λ}_{xx} )}^{j - q} , {E ( {Λ}_{yy} )}^{j - q} , - 2 {E ( {Λ}_{xx} )}^{j - q} ]}^{T} \\ \begin{matrix}{Λ}_{xx} = [ 〈 {x}_{1}^{s , {F}_{2}} , {x}_{1}^{s , {F}_{2}} 〉 , … , 〈 {x}_{1}^{s , {F}_{2}} , {x}_{n}^{s , {F}_{2}} 〉 , … , \\ {〈 {x}_{n}^{s , {F}_{2}} , {x}_{1}^{s , {F}_{2}} 〉 , … , 〈 {x}_{n}^{s , {F}_{2}} , {x}_{n}^{s , {F}_{2}} 〉 ]}^{T}\end{matrix} \\ \begin{matrix}{Λ}_{yy} = [ 〈 {x}_{1}^{t , {F}_{2}} , {x}_{1}^{t , {F}_{2}} 〉 , … , 〈 {x}_{1}^{t , {F}_{2}} , {x}_{n}^{t , {F}_{2}} 〉 , … , \\ {〈 {x}_{n}^{t , {F}_{2}} , {x}_{1}^{t , {F}_{2}} 〉 , … , 〈 {x}_{n}^{t , {F}_{2}} , {x}_{n}^{t , {F}_{2}} 〉 ]}^{T}\end{matrix} \\ \begin{matrix}{Λ}_{xy} = [ 〈 {x}_{1}^{s , {F}_{2}} , {x}_{1}^{t , {F}_{2}} 〉 , … , 〈 {x}_{1}^{s , {F}_{2}} , {x}_{n}^{t , {F}_{2}} 〉 , … , \\ {〈 {x}_{n}^{s , {F}_{2}} , {x}_{1}^{t , {F}_{2}} 〉 , … , 〈 {x}_{n}^{s , {F}_{2}} , {x}_{n}^{t , {F}_{2}} 〉 ]}^{T}\end{matrix}\end{matrix} ,$$

[symbol] represents the reproducing kernel Hilbert space, and a, b, c represent the slope, the intercept and the order of the polynomial kernel function, respectively.

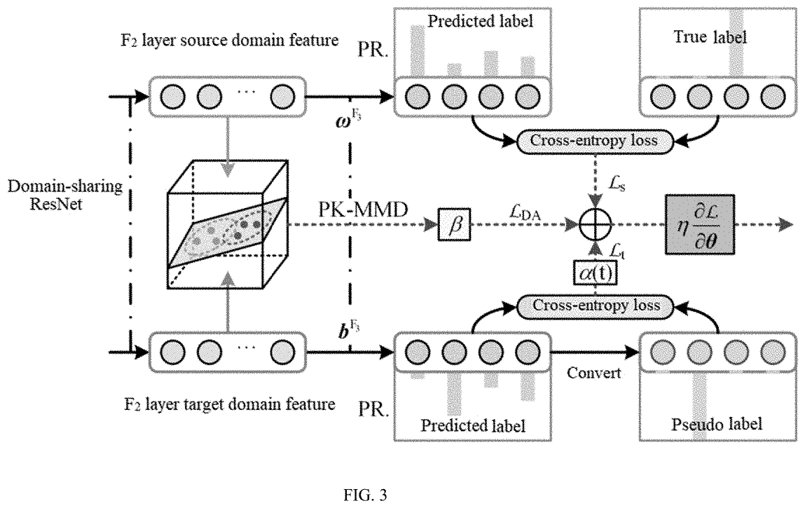

Step 4: as shown in FIG. 3, the transferrable fault features obtained in step 2 are inputted into the output layer F₃ of the deep residual network, and the activation function Softmax is adopted to generate the probability distribution [symbol] of the health states of the sample as follows:

[symbol]

=[P( [symbol] =q| [symbol] ;θ^{F}^{₂}θ^{F}^{₂})]_{q=1}^{k},

wherein, the probability calculation formula of the q^{th} sample is as follows:

$$P ( {y}_{i}^{𝒟} = q \vert {x}_{i}^{𝒟 , {F}_{2}} ; {θ}^{{F}_{3}} ) = \frac{exp ( {w}_{q}^{{F}_{3}} \cdot {x}_{i}^{𝒟 , {F}_{2}} + {b}_{q}^{{F}_{3}} )}{{\sum }_{q = 1}^{ϕ} exp ( {w}_{q}^{{F}_{3}} \cdot {x}_{i}^{𝒟 , {F}_{2}} + {b}_{q}^{{F}_{3}} )} ,$$

wherein, θ^{F}^{₃}={w^{F}^{₃},b^{F}^{₃}} is the parameter to be trained of the output layer F₃, and [symbol] is the bearing data identifier; then, the probability distribution is converted into the pseudo label of the target sample: ŷᵢ^{t}=[ŷ₁^{t} ŷ₂^{t} . . . ŷ_{q}^{t} . . . ŷₖ^{t}],

wherein,

$${\hat{y}}_{q}^{t} = \{ \begin{matrix}1 & q = {arg max}_{q} {Γ}_{i}^{t} \\ 0 & others\end{matrix} .$$

Step 5: the distribution discrepancy [symbol] (xᵢ^{s,F}^{₂}, xᵢ^{t,F}^{₂}) of the transferrable fault features obtained in step 3 is combined with the pseudo label ŷᵢ^{t} of the target bearing samples obtained in step 4 to train the transfer diagnosis model, that is, to minimize the objective function:

$$J ( θ ) = - \frac{1}{{n}_{s}} {\sum }_{i = 1}^{{n}_{s}} {( {y}_{i}^{s} )}^{T} \cdot ln ( {Γ}_{i}^{s} ) + β \cdot {D}_{ℋ}^{2} ( {x}_{i}^{s , {F}_{2}} , {x}_{i}^{t , {F}_{2}} ) - α \cdot \frac{1}{{n}_{t}} {\sum }_{j = 1}^{{n}_{t}} {( {\hat{y}}_{j}^{t} )}^{T} \cdot ln ( {Γ}_{j}^{t} ) ,$$

wherein, α is the tradeoff parameter of the adaptation item of the transferrable fault feature distribution, β is the tradeoff parameter of the pseudo label training item, and θ is the parameter to be trained. The equation in step 5 includes three terms, wherein, the first term is to minimize the cross-entropy loss between the predicted label and the true label of the monitoring data of the source bearing, and the second term is to minimize the maximum mean discrepancy value of the polynomial kernel induced between the deep transferrable fault feature of the source bearing and the deep transferrable fault feature of the target bearing; the last item is to minimize the cross-entropy loss between the predicted label and the pseudo label of the monitoring data of the target bearing.

Step 6: the monitoring data of the target bearings are inputted into the trained transfer diagnosis model, the label probability distribution corresponding to the features of the data samples is outputted, and the sample label corresponding to the maximum probability is taken as the health state {yᵢ^{t}}ᵢ₌₁ⁿ^{ₜ} of the bearings.

Example: the health state transfer diagnosis of the bearings on the vehicle wheelset is taken as an example to verify the feasibility of the present invention.

Data set A is from the bearing data center of Case Western Reserve University in the United States. The vibration samples in the data set A are collected from the SKF6205 rolling element bearings on the motor drive shaft, which includes four states, i.e. normal, inner ring fault with a damaged diameter of 0.3556 mm, outer ring fault with the damaged diameter of 0.3556 mm, and roller fault with the damaged diameter of 0.3556 mm. The bearing data in each health state are collected under different loads (0 HP, 1 HP, 2 HP, 3 HP) with a sampling frequency of 12 kHz.

Data set B is from the 552732QT rolling element bearings on the vehicle wheelset. The data set B includes vibration samples in four states, i.e. normal, inner ring abrasion, outer ring abrasion and roller abrasion. The vibration samples in each health state are collected at a speed of 500 r/min, a radial load of 9800 N, and a sampling frequency of 12.8 kHz. The data set B includes 4368 samples.

TABLE 1
transfer diagnostic data sets

| | Bearing | | Number of | |
|---|---|---|---|---|
| Data set | type | State | samples | Working condition |
| Data set A | SKF6205 | Normal | 1616 (404 × 4) | 0 HP (1797 r/min) |
| | | Inner ring fault | | 1 HP (1772 r/min) |
| | | Inner ring fault | | 2 HP (1750 r/min) |
| | | Rolling body fault | | 3 HP (1730 r/min) |
| Data set B | 552732QT | Normal | 4368 (1092 × 4) | 500 r/min |
| | | Inner ring abrasion | | (four kinds of load) |
| | | Outer ring abrasion | | |
| | | Rolling body abrasion | | |

Using the data (the data set A) of different bearing faults that are simulated in the laboratory, the accumulated diagnostic knowledge is transferred to recognize the health states (the data set B) of the bearing on the vehicle wheelset, and the transfer task A→B is adopted to verify the feasibility of the present invention.

The method of the present invention is adopted to carry out the transfer diagnosis on the health states of the bearing on the vehicle wheelset and is compared with other methods, wherein each method takes the optimal parameter. The source samples (data set A) are used to train the residual network. The residual network structures of features extracted from all methods are identical. The target samples (data set B) are used for accuracy testing. The comparison results are shown in Table 2.

TABLE 2
Comparison results of diagnostic effects by different methods

| Diagnostic method | Method structure | Accuracy (%) |
|---|---|---|
| Standard residual network | Residual network without transfer learning | 55.89 ± 7.39 |
| G-ResNet | Residual network + MMD of Gaussian | 84.32 ± 8.29 |
| | kernel induced | |
| P-ResNet | Residual network + MMD of polynomial | 87.76 ± 4.62 |
| | kernel induced | |

From the comparison results in table 2, the maximum mean discrepancy measurement method based on Gaussian kernel induced of the present invention has a diagnostic accuracy of 87.76 % with the standard error of 4.62 %, which is obviously superior to other methods.

From the above analysis, it can be seen that the calculation time of the maximum mean discrepancy (MMD) of polynomial kernels is mainly influenced by the sequence of polynomial kernels and the number of cross-domain samples. In order to analyze the influence of the amount of data on the two methods, the parameter C is set as 10, and the comparison results are obtained by increasing the minimum batch size and decreasing the number of the source-target samples. The comparison results are shown in Table 3.

TABLE 3
comparison results of the calculation time of MMD of Gaussian kernel
induced and the calculation time of MMD of polynomial kernel induced

| | | | Calculation time (s) | |
|---|---|---|---|---|
| Minimum | Sample batch size | | MMD of Gaussian | MMD of polynomial |
| batch size | Data set A | Data set B | kernel induced | kernel induced |
| 5 | 323 | 873 | 148.69 | 0.53 |
| 10 | 161 | 436 | 36.28 | 0.12 |
| 15 | 107 | 291 | 16.05 | 0.06 |
| 20 | 80 | 218 | 8.92 | 0.03 |
| 25 | 64 | 174 | 5.68 | 0.02 |

According to the comparison results in the table 3, under the same minimum batch size of samples, the calculation time of the MMD of polynomial kernel induced is obviously less than that of the MMD of Gaussian kernel induced, which indicates that the maximum mean discrepancy method of polynomial kernel induced of the present invention can effectively reduce invalid calculation, and has relatively high valid calculation efficiency when dealing with a large number of samples.

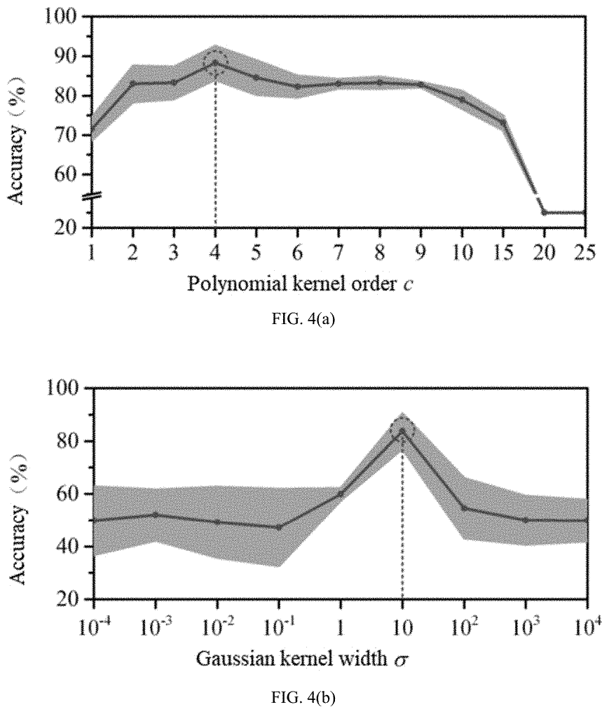

The sensitivity of the transfer diagnosis performance to the kernel parameters between the deep transfer diagnosis models of the polynomial kernel induced and the Gaussian kernel induced is compared and analyzed, and the changes of the diagnostic performance of the two transfer diagnosis models with the kernel parameters are shown in FIG. 4(a) and FIG. 4(b). The transfer diagnosis model of polynomial kernel induced is robust to the order of a kernel within a wide selection range. With the increase of the order of a kernel, the transfer diagnosis accuracy of the model increases gradually. When the order continues to increase, the transfer diagnosis accuracy decreases gradually due to the influence of overfitting. The diagnostic accuracy of the transfer diagnosis model of Gaussian kernel induced is sensitive to the parameters, and the standard deviation of the diagnosis result is large. The above results show that the maximum mean discrepancy method of the polynomial kernel can improve the accuracy of the deep transfer diagnosis model and also improve the robustness of the transfer diagnosis performance of the model to the kernel parameters.

1. A fault transfer diagnosis method for rolling element bearings based on polynomial kernel induced feature distribution adaptation, comprising the following steps:
step 1: obtaining R kinds of sample data set {(xᵢ^{s},yᵢ^{s})}ᵢ₌₁ⁿ^{ₛ} with health state labels from source rolling element bearings, wherein, xᵢ^{s}∈R^{N×1} an i^{th} source sample and the i^{th} source sample is composed of N vibration signal data points, health state labels of the rolling element bearings correspond to the i^{th} source sample, and the health state labels of the rolling element bearings are yᵢ∈{1, 2, 3, . . . , R}, and nₛ is a number of labeled samples; and obtaining monitoring data set {xᵢ^{t}}ᵢ₌₁ⁿₜ from target rolling element bearings, wherein nₜ is a number of unlabeled samples;
step 2: inputting the sample data set of the source rolling element bearings and the monitoring data set of the target rolling element bearings into a domain-sharing deep residual network; extracting transferrable fault features in the sample data set of the source rolling element bearings and transferrable fault features in the monitoring data set of the target rolling element bearings layer by layer to obtain the transferrable fault features x^{s,F}^{₂}=ƒ_{θ}(xᵢ^{s}) of the source rolling element bearings and the transferrable fault features x^{t,F}^{₂}=ƒ_{θ}(xᵢ^{t}) of the target rolling element bearings;
step 3: adopting a maximum mean discrepancy measurement method with polynomial kernel induced to measure a distribution discrepancy [symbol] (xᵢ^{s,F}^{₂},xᵢ^{t,F}^{₂}) of the transferrable fault features in the sample data set of the source rolling element bearings and the transferrable fault features in the monitoring data set of the target rolling element bearings as follows:
$${D}_{ℋ}^{2} ( {x}_{i}^{s , {F}_{2}} , {x}_{i}^{t , {F}_{2}} ) = {\sum }_{j = 1}^{c} ( \begin{matrix}c \\ j\end{matrix} ) {a}^{j} {b}^{c - j} {‖ {E ( {x}_{i}^{s , {F}_{2}} )}_{j} - {E ( {x}_{i}^{t , {F}_{2}} )}_{j} ‖}_{ℋ}^{2} , \\ wherein , \\ \{ \begin{matrix}{‖ {E ( {x}_{i}^{s , {F}_{2}} )}_{j} - {E ( {x}_{i}^{t , {F}_{2}} )}_{j} ‖}_{ℋ}^{2} = {\sum }_{q = 0}^{j} ( \begin{matrix}j \\ q\end{matrix} ) ( {v}_{q}^{T} \cdot {μ}_{j - q} ) \\ {v}_{q}^{T} = [ {E [ {Λ}_{xx} - E ( {Λ}_{xx} ) ]}^{q} , {E [ {Λ}_{yy} - E ( {Λ}_{yy} ) ]}^{q} , {E [ {Λ}_{xy} - E ( {Λ}_{xy} ) ]}^{q} ] \\ {μ}_{j - q} = {[ {E ( {Λ}_{xx} )}^{j - q} , {E ( {Λ}_{yy} )}^{j - q} , - 2 {E ( {Λ}_{xx} )}^{j - q} ]}^{T} \\ \begin{matrix}{Λ}_{xx} = [ 〈 {x}_{1}^{s , {F}_{2}} , {x}_{1}^{s , {F}_{2}} 〉 , … , 〈 {x}_{1}^{s , {F}_{2}} , {x}_{n}^{s , {F}_{2}} 〉 , … , \\ {〈 {x}_{n}^{s , {F}_{2}} , {x}_{1}^{s , {F}_{2}} 〉 , … , 〈 {x}_{n}^{s , {F}_{2}} , {x}_{n}^{s , {F}_{2}} 〉 ]}^{T}\end{matrix} \\ \begin{matrix}{Λ}_{yy} = [ 〈 {x}_{1}^{t , {F}_{2}} , {x}_{1}^{t , {F}_{2}} 〉 , … , 〈 {x}_{1}^{t , {F}_{2}} , {x}_{n}^{t , {F}_{2}} 〉 , … , \\ {〈 {x}_{n}^{t , {F}_{2}} , {x}_{1}^{t , {F}_{2}} 〉 , … , 〈 {x}_{n}^{t , {F}_{2}} , {x}_{n}^{t , {F}_{2}} 〉 ]}^{T}\end{matrix} \\ \begin{matrix}{Λ}_{xy} = [ 〈 {x}_{1}^{s , {F}_{2}} , {x}_{1}^{t , {F}_{2}} 〉 , … , 〈 {x}_{1}^{s , {F}_{2}} , {x}_{n}^{t , {F}_{2}} 〉 , … , \\ {〈 {x}_{n}^{s , {F}_{2}} , {x}_{1}^{t , {F}_{2}} 〉 , … , 〈 {x}_{n}^{s , {F}_{2}} , {x}_{n}^{t , {F}_{2}} 〉 ]}^{T}\end{matrix}\end{matrix} ,$$ [symbol]
represents a reproducing kernel Hilbert space, and a, b, c represent a slope, an intercept and an order of a polynomial kernel function, respectively;
step 4: inputting the transferrable fault features of the source rolling element bearings and the transferrable fault features of the target rolling element bearings into an output layer F₃ of the domain-sharing deep residual network, and adopting an activation function Softmax to generate a probability distribution [symbol] of health states of input samples of the sample data set as follows: [symbol]
=[P( [symbol] | [symbol] ;θ^{F}^{₃})]_{q=1}^{k},
wherein, a probability calculation formula of a q^{th} sample is as follows:
$$P ( {y}_{i}^{𝒟} = q \vert {x}_{i}^{𝒟 , {F}_{2}} ; {θ}^{{F}_{3}} ) = \frac{exp ( {w}_{q}^{{F}_{3}} \cdot {x}_{i}^{𝒟 , {F}_{2}} + {b}_{q}^{{F}_{3}} )}{{\sum }_{q = 1}^{ϕ} exp ( {w}_{q}^{{F}_{3}} \cdot {x}_{i}^{𝒟 , {F}_{2}} + {b}_{q}^{{F}_{3}} )} ,$$
wherein, θ^{F}^{₃}={w^{F}^{₃},b^{F}^{₃}} is a parameter to be trained of the output layer F₃ and [symbol] is a bearing data identifier;
converting the probability distribution [symbol] into pseudo labels ŷᵢ^{t} of the target rolling element bearings: ŷᵢ^{t}=[ŷ₁^{t} ŷ₂^{t} . . . ŷ_{q}^{t} . . . ŷₖ^{t}],
wherein,
$${\hat{y}}_{q}^{t} = \{ \begin{matrix}1 & q = {arg max}_{q} {Γ}_{i}^{t} \\ 0 & others\end{matrix} ;$$
step 5: combining the distribution discrepancy [symbol] (xᵢ^{s,F}^{₂}, xᵢ^{t,F}^{₂}) obtained in step 3 with the pseudo labels r of the target rolling element bearings obtained in step 4 to train a transfer diagnosis model, wherein an objective function is minimized as follows:
$$J ( θ ) = - \frac{1}{{n}_{s}} {\sum }_{i = 1}^{{n}_{s}} {( {y}_{i}^{s} )}^{T} \cdot ln ( {Γ}_{i}^{s} ) + β \cdot {D}_{ℋ}^{2} ( {x}_{i}^{s , {F}_{2}} , {x}_{i}^{t , {F}_{2}} ) - α \cdot \frac{1}{{n}_{t}} {\sum }_{j = 1}^{{n}_{t}} {( {\hat{y}}_{j}^{t} )}^{T} \cdot ln ( {Γ}_{j}^{t} ) ,$$
wherein, α is a tradeoff parameter of a transferrable fault feature distribution adaptation item, β is a tradeoff parameter of a pseudo label training item, and θ is a parameter to be trained; and
step 6: inputting the monitoring data set of the target rolling element bearings into a trained transfer diagnosis model, outputting a label probability distribution corresponding to the transferrable fault features in the sample data set of the source rolling element bearings, and taking sample labels corresponding to a maximum probability as the health states {yᵢ^{t}}ᵢ₌₁ⁿ^{ₜ} of the rolling element bearings.
